(19) United States
(12) Patent Application Publication
(10) Pub. No.: US 2020/0014284 A1
(43) Pub. Date: Jan. 9, 2020

(54) ELECTRIC ACTUATOR

(71) Applicant: Nidec Tosok Corporation, Zama-shi (JP)

(72) Inventors: Yutaka UEMATSU, Zama-shi (JP); Tadayuki HATSUDA, Kyoto (JP); Kazumi SHINKAI, Zama-shi (JP); Shun KATO, Zama-shi (JP); Shuichi KINJO, Zama-shi (JP); Fumito TAMURA, Kyoto (JP)

(21) Appl. No.: 16/492,963

(22) PCT Filed: Mar. 19, 2018
(86) PCT No.: PCT/JP2018/010687

§ 371 Date: Sep. 11, 2019

(30) Foreign Application Priority Data
Mar. 31, 2017 (JP) 2017-072602

(51) Int. Cl. H02K 11/215; H02K 7/116

(52) U.S. Cl. CPC H02K 11/215; H02K 2211/03; H02K 7/116

(57) ABSTRACT

An electric actuator includes a motor that includes a motor shaft extending axially, a decelerator that is joined to one axial side of the motor shaft, an output that includes an output shaft to which rotation of the motor shaft is transmitted via the decelerator, and a control board that is electrically connected to at least the motor. The motor and the output are disposed radially side by side with respect to the motor, the control board extends from a position axially overlapping the motor shaft to a position axially overlapping the output shaft, and the control board includes a motor sensor that detects a rotation angle of the motor shaft, and an output sensor that detects a rotation angle of a driven shaft joined to the output shaft.

### CROSS REFERENCE TO RELATED APPLICATIONS

This is a U.S. national stage of PCT Application No. PCT/JP2018/010687, filed on Mar. 19, 2018, and priority under 35 U.S.C. § 119(a) and 35 U.S.C. § 365(b) is claimed from Japanese Application No. 2017-072602, filed Mar. 31, 2017; the entire disclosures of each application are hereby incorporated herein by reference.

### 1. FIELD OF THE INVENTION

The present disclosure relates to an electric actuator.

### 2. BACKGROUND

In the related art, electric actuators including a motor and a speed reducer are known. In of such electric actuators, rotation position detecting means for detecting a rotation angle is provided in an output member joined to the speed reducer (for example, refer to Japanese Patent Laid-open No. 2015-23761).

When a sensor is provided in an output shaft of an electric actuator, an attachment position of the sensor is spaced away from a motor. Therefore, in addition to a wiring or a substrate for electrically connecting a connector for external connection and the motor to each other, there is a need to install a wiring or a substrate for being electrically connected to a sensor for the output shaft. As a result, equipment is likely to be increased in size, and a manufacturing step also becomes troublesome.

### SUMMARY

Example embodiments of the present disclosure provide electric actuators each internally equipped with a sensor that has excellent assembly workability and structured to miniaturize equipment.

According to example embodiments of the present disclosure, an electric actuator includes a motor that includes a motor shaft extending axially, a decelerator joined to one axial side of the motor shaft, an output that includes an output shaft to which rotation of the motor shaft is transmitted via the decelerator, and a control board that is electrically connected to at least the motor. The motor and the output are disposed radially side by side with respect to the motor, the control board extends from a position axially overlapping the motor shaft to a position axially overlapping the output shaft, and the control board includes a motor sensor that detects a rotation angle of the motor shaft, and an output sensor that detects a rotation angle of a driven shaft joined to the output shaft.

According to example embodiments of the present disclosure, electric actuators are internally equipped with a sensor that has excellent assembly workability and are structured to miniaturize equipment.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view of an electric actuator of an example embodiment of the present disclosure.

### DETAILED DESCRIPTION

### Electric Actuator

Hereinafter, an electric actuator of an example embodiment will be described with reference to the drawings.

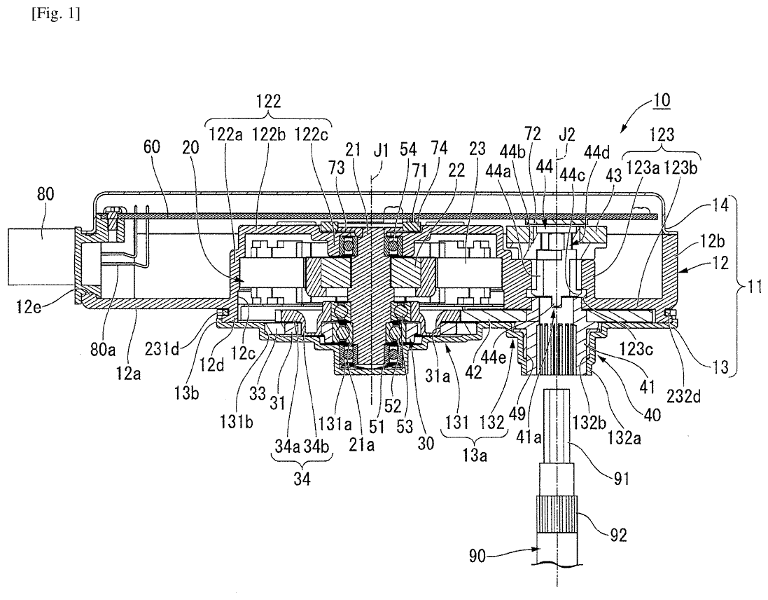

FIG. 1 is a cross-sectional view of the electric actuator of the present example embodiment.

An electric actuator 10 of the present example embodiment is used by being joined to a driven shaft 90. The electric actuator 10 rotates the driven shaft 90 around an axis.

The electric actuator 10 includes a housing 11, a motor portion 20 that has a motor shaft 21 extending axially along a first central axis J1, a deceleration mechanism 30, an output portion 40, a control board 60, a first bearing 51, a second bearing 52, a third bearing 53, a fourth bearing 54, and an external connector 80. The first bearing 51 to the fourth bearing 54 are ball bearings, for example. The axial direction of the first central axis J1 is parallel to the up-down direction in FIG. 1.

In the following description, the axial direction of the first central axis J1 will be simply referred to as “the axial direction”, axially upward in FIG. 1 will be simply referred to as “above or upward”, and axially downward in FIG. 1 will be simply referred to as “below or downward”. In addition, the radial direction about the first central axis J1 will be simply referred to as “the radial direction”, and the circumferential direction about the first central axis J1 will be simply referred to as “the circumferential direction”. Above (upward) and below (downward) are merely names for describing the relative positional relationship between portions. Actual disposition relationships or the like may be disposition relationships or the like other than disposition relationships or the like expressed using these names. Above (upward) corresponds to the other axial side, and below (downward) corresponds to one axial side.

The housing 11 has a housing main body 12 which accommodates the motor portion 20, the deceleration mechanism 30, and the output portion 40; a lower cover member 13 which is disposed on the side below the housing main body 12; and an upper cover member 14 which is disposed on the side above the housing main body 12.

The housing main body 12 is a bottomed box-shaped container which opens upward. The housing main body 12 has a bottom wall 12a which spreads in a direction orthogonal to the first central axis J1 and a circumferential wall 12b which extends upward from an outer circumferential end of the bottom wall 12a. The bottom wall 12a has a penetration hole 12c which axially penetrates the bottom wall 12a and a tubular protruding wall portion 12d which extends axially downward from an end edge of the penetration hole 12c. That is, the housing 11 has the penetration hole 12c and the protruding wall portion 12d.

The housing main body 12 has a motor holding portion 122 which holds the motor portion 20 and an output portion holding part 123 which holds the output portion 40. The motor holding portion 122 and the output portion holding part 123 are disposed radially side by side inside the penetration hole 12c. The housing main body 12 has a penetration portion 12e which radially penetrates the circumferential wall 12b. The external connector is inserted into the penetration portion 12e and is fixed thereto.

The motor holding portion 122 has a cylindrical tube portion 122a which extends axially and a toric lid portion 122b which spreads radially inward from an upper end of the tube portion 122a. An lower opening portion of the tube portion 122a is positioned inside the penetration hole 12c. The tube portion 122a radially surrounds the outside of the motor portion 20. The lid portion 122b covers the side above the motor portion 20. The lid portion 122b has a cylindrical bearing holding part 122c which holds the fourth bearing 54 in the middle.

The output portion holding part 123 is disposed while being radially adjacent to the motor holding portion 122 inside the penetration hole 12c. The output portion holding part 123 has a cylindrical tube portion 123a which extends axially about a second central axis J2 and a support wall portion 123b which spreads radially outward from a lower end of the tube portion 123a and is connected to a circumferential edge of the penetration hole 12c.

The protruding wall portion 12d surrounding the penetration hole 12c partially accommodates gears of the deceleration mechanism 30 and the output portion 40. In a region surrounded by the protruding wall portion 12d, a region axially overlapping the motor holding portion 122 is a region accommodating the gears of the deceleration mechanism 30, and a region axially overlapping the output portion holding part 123 is a region accommodating the gears of the output portion 40.

The lower cover member 13 is fixed to the protruding wall portion 12d of the housing main body 12. The lower cover member 13 blocks the penetration hole 12c from the side therebelow. The lower cover member 13 has a lid plate portion 13a which spreads in a direction orthogonal to the axial direction and tubular side wall portions 13b which extend axially upward from an end edge of the lid plate portion 13a. The side wall portions 13b surround the outer circumference of the protruding wall portion 12d of the housing main body 12 and face each other in a direction orthogonal to the axial direction. The side wall portion 13b of the lower cover member 13 is fixed to the protruding wall portion 12d by being caulked at a plurality of places.

The lower cover member 13 has a deceleration mechanism cover 131 which axially covers the deceleration mechanism 30 and an output portion cover 132 which axially covers the output portion 40.

The deceleration mechanism cover 131 has a disk shape about the first central axis J1 when viewed from the side therebelow. The deceleration mechanism cover 131 has a plurality of recessed accommodation portions 131a and 131b which are recessed downward. Both the recessed accommodation portions 131a and 131b have a bottomed cylindrical shape about the first central axis J1. The recessed accommodation portion 131a is disposed in a radially middle portion and accommodates the first bearing 51. The recessed accommodation portion 131b is positioned on the side above the recessed accommodation portion 131b and accommodates the gears of the deceleration mechanism 30.

The output portion cover 132 has a disk shape about the second central axis J2 when viewed from the side therebelow. The output portion cover 132 has a cylindrical tube portion 132a which extends axially downward about the second central axis J2. The tube portion 132a has a penetration hole 132b which penetrates the output portion cover 132. A cylindrical bush 49 is disposed inside the tube portion 132a. The bush 49 is fitted into the penetration hole 132b. The bush 49 has a flange portion which protrudes radially outward in an upper end portion. The flange portion of the bush 49 comes into contact with the upper surface of the output portion cover 132 from the side thereabove.

The upper cover member 14 is fixed to an upper end portion of the circumferential wall 12b of the housing main body 12. The upper cover member 14 blocks an opening of the housing main body 12 on the side thereabove. The control board 60 is disposed between the upper surface of the motor holding portion 122 and the upper cover member 14. The control board 60 has a plate shape spreading in a direction orthogonal to the axial direction. Inside the housing main body 12, the control board 60 is fixed at a position where the motor holding portion 122 and the output portion holding part 123 are covered from the side thereabove. The control board 60 is electrically connected to a coil wire which extends from the motor portion 20 and a metal terminal 80a which extends from the external connector 80.

The motor portion 20 has the motor shaft 21, a rotor 22, and a stator 23. The motor shaft 21 is rotatably supported around the first central axis J1 by the first bearing 51 and the fourth bearing 54. The motor shaft 21 extends downward from the rotor 22 and is joined to the deceleration mechanism 30.

The rotor 22 has a cylindrical rotor core which is fixed to an outer circumferential surface of the motor shaft 21 and a magnet which is fixed to an outer circumferential surface of the rotor core. The stator 23 has an annular stator core which radially surrounds the outside of the rotor 22 and a plurality of coils which are mounted on the stator core. The stator 23 is fixed to an inner circumferential surface of the tube portion 122a.

A ring-shaped motor portion sensor magnet 74 is attached to an upper end of the motor shaft 21 with a magnet holder 73 interposed therebetween. The magnet holder 73 and the motor portion sensor magnet 74 are disposed between the lid portion 122b of the motor holding portion 122 and the control board 60. A motor portion sensor 71 is disposed at a position in the control board 60 facing the motor portion sensor magnet 74. The motor portion sensor 71 is a Hall element or an MR element (magneto-resistive element), for example. For example, three motor portion sensors 71 formed of Hall elements are disposed around the first central axis J1.

The deceleration mechanism 30 is disposed on the side below the motor portion 20. The motor shaft 21 axially penetrates the deceleration mechanism 30. The deceleration mechanism 30 is disposed on a side radially outward from a lower part of the motor shaft 21. The deceleration mechanism 30 is accommodated between the motor portion 20 and the deceleration mechanism cover 131. The deceleration mechanism 30 has an external gear 31, an internal gear 33, and an output gear 34.

The external gear 31 has a substantially toric plate shape spreading in a plane orthogonal to the axial direction about an eccentric portion 21a of the motor shaft 21. A gear portion is provided on a radially outer surface of the external gear 31. The external gear 31 is connected to the eccentric portion 21a with the second bearing 52 interposed therebetween. The external gear 31 has a plurality of pin holes 31a which axially penetrate the external gear 31. For example, eight pin holes are provided as the plurality of pin holes 31a. The plurality of pin holes 31a are disposed at equal intervals throughout the circumference around the central axis of the external gear 31.

The internal gear 33 is fixed while radially surrounding the outside of the external gear 31 and meshes with the external gear 31. The internal gear 33 has a substantially toric shape about the first central axis J1. The external shape of the internal gear 33 is a polygonal shape (in the present example embodiment, a dodecagonal shape). The internal gear 33 is fitted into the recessed accommodation portion 131b of the deceleration mechanism cover 131 having the same polygonal shape and is fixed thereto. The gear portion is provided on the inner circumferential surface of the internal gear 33. The gear portion of the internal gear 33 meshes with the gear portion of the external gear 31.

The output gear 34 is an external gear which is disposed on the side above the external gear 31. The output gear 34 has a toric portion 34a and a plurality of carrier pins 34b. The toric portion 34a has a toric plate shape radially spreading about the first central axis J1. The plurality of carrier pins 34b have a columnar shape protruding downward from the lower surface of the toric portion 34a. For example, eight carrier pins 34b are provided. The plurality of carrier pins 34b are disposed at equal intervals throughout the circumference about the first central axis J1. The carrier pins 34b are inserted into the pin holes 31a, respectively. The output gear 34 meshes with a driving gear 42 (which will be described below).

The output portion 40 is a part outputting a driving force of the electric actuator 10. The output portion 40 has an output shaft 41, a driving gear 42, an 43, and a magnet holder 44. The output portion 40 is held by the output portion holding part 123 and the output portion cover 132.

The output shaft 41 has a cylindrical shape extending along the second central axis J2. The output shaft 41 has a spline groove in a lower portion on the inner circumferential surface. The output shaft 41 has a recessed portion 41a recessed axially at the upper end thereof. The driving gear 42 is fixed to the outer circumferential surface of the output shaft 41. The driving gear 42 has a toric plate shape radially spreading about the second central axis J2. The lower portion of the output shaft 41 is inserted into the bush 49 of the output portion cover 132 from the side thereabove. The upper portion of the output shaft 41 is inserted into the tube portion 123a of the output portion holding part 123 from the side therebelow.

The magnet holder 44 is a substantially cylindrical member extending along the second central axis J2. The magnet holder 44 has a tubular portion 44a which extends axially and a toric flange portion 44b which radially spreads from an upper portion of the tubular portion 44a. The toric output portion sensor magnet 43 is fixed to the upper surface of the flange portion 44b.

The tubular portion 44a of the magnet holder 44 is inserted into the tube portion 123a of the output portion holding part 123. The magnet holder 44 has a movement restriction portion 44c formed of a projection protruding radially outward from the outer circumferential surface of the lower end portion of the tubular portion 44a. The movement restriction portion 44c is inserted into a recessed groove 123c which is provided on the inner circumferential surface of the tube portion 123a and extends circumferentially. The movement restriction portion 44c restricts axial movement of the magnet holder 44. The magnet holder 44 has a hexagonal hole portion 44d having a hexagonal shape in a cross section on the upper portion side on the inner circumferential surface. The magnet holder 44 has a projection portion 44e which protrudes axially downward at the lower end of the tubular portion 44a. The projection portion 44e is inserted into the recessed portion 41a of the output shaft 41.

The output portion sensor magnet 43 is disposed between the output portion holding part 123 and the control board 60. An output portion sensor 72 is disposed at a position facing the output portion sensor magnet 43 of the control board 60. The output portion sensor 72 is an MR element, for example. An MR element and a Hall element may be used together as the output portion sensor 72.

The output portion 40 can be joined to the driven shaft 90. In a distal end part inserted into the electric actuator 10, the driven shaft 90 has a hexagonal portion 91 which has a regular hexagonal shape in a cross section and a spline portion 92 which is positioned on a side below the hexagonal portion 91 (base end side of the driven shaft 90). When the hexagonal portion 91 is fitted into the hexagonal hole portion 44d of the magnet holder 44, the driven shaft 90 and the magnet holder 44 are connected to each other. In addition, when the spline portion 92 is fitted into the spline groove of the output shaft 41, the driven shaft 90 and the output shaft 41 are connected to each other.

In the electric actuator 10, as illustrated in FIG. 1, the motor portion 20 and the output portion 40 are disposed radially side by side. The control board 60 extends from a position axially overlapping the motor shaft 21 to a position axially overlapping the output shaft 41 and is disposed to overlap both the motor portion 20 and the output portion 40 when viewed in the axial direction. The control board 60 has the motor portion sensor 71 for detecting a rotation angle of the motor shaft 21, and the output portion sensor 72 for detecting a rotation angle of the driven shaft 90 joined to the output shaft 41.

According to this constitution, since the motor portion sensor 71 and the output portion sensor 72 are mounted on the common control board 60, wiring routing performed when a control board and a sensor are disposed at positions away from each other becomes unnecessary. Since the motor portion sensor 71 and the output portion sensor 72 can be disposed by only performing installation work of the control board 60, assembly workability is improved. Since an installation space for wirings is not necessary, the actuator can also be miniaturized.

In the electric actuator 10, the volume of the output portion sensor magnet 43 is larger than the volume of the motor portion sensor magnet 74. Since the number of poles of the output portion sensor magnet 43 can be increased by increasing the size of the output portion sensor magnet 43, the output portion sensor 72 having high resolution can be used. Accordingly, the rotation angle of the driven shaft 90 can be controlled with high accuracy.

The output portion sensor magnet 43 is positioned on a side radially outward from the motor holding portion 122 of the motor portion 20. The output portion sensor magnet 43 is positioned axially between the output shaft 41 and the control board 60. Due to this constitution, the output portion sensor magnet 43 having a significant volume can be disposed in the output portion 40 without increasing the size of the housing 11.

The output portion sensor magnet 43 radially overlaps the motor portion sensor magnet 74. That is, the axial positions of the output portion sensor magnet 43 and the motor portion sensor magnet 74 approximately coincide with each other. Due to this constitution, both the output portion sensor magnet 43 and the motor portion sensor magnet 74 can be disposed closer to the control board 60. Accordingly, sensors having high resolution and high accuracy can be used as the motor portion sensor 71 and the output portion sensor 72. In addition, the electric actuator 10 can be miniaturized axially. Moreover, when a sensor having sufficiently high accuracy is used as the output portion sensor 72, the motor portion 20 can be driven using only the output portion sensor 72 while not using the motor portion sensor 71.

The motor portion sensor magnet 74 is disposed at a portion protruding outward (upward) from the motor holding portion 122 of the motor shaft 21. Due to this constitution, since the motor portion sensor magnet 74 is disposed on a side outward (upward) from the fourth bearing 54 supporting the motor shaft 21, the motor portion sensor magnet 74 having a small diameter can be installed in a distal end portion of the motor shaft 21. If the motor portion sensor magnet 74 is attached between the fourth bearing 54 and the third bearing 53, in order to cause the motor portion sensor magnet 74 and the control board 60 to face each other, there is a need to increase the size of the magnet holder 73 and to radially wrap around the outside of the fourth bearing 54. Consequently, both the magnet holder 73 and the motor portion sensor magnet 74 are increased in size. In contrast to such a constitution, significant miniaturization of the motor portion sensor magnet 74 of the present example embodiment can be realized, and therefore the electric actuator 10 can also be miniaturized.

The lid portion 122b of the motor holding portion 122, the motor portion sensor magnet 74, and the output portion sensor magnet 43 are disposed to radially overlap each other. Due to this constitution, the axial positions of the lid portion 122b, the motor portion sensor magnet 74, and the output portion sensor magnet 43 approximately coincide with each other. Accordingly, the lid portion 122b, the motor portion sensor magnet 74, and the output portion sensor magnet 43 can be disposed closer to the control board 60. The electric actuator 10 can be shortened axially.

The motor holding portion 122 is formed of a non-magnetic material. Due to this constitution, since magnetic interference with surrounding magnetic components is eliminated, the motor portion sensor 71, the output portion sensor 72, the motor portion sensor magnet 74, and the output portion sensor magnet 43 can be disposed closer to the motor holding portion 122. The electric actuator 10 can be miniaturized.

The control board 60 is a rigid substrate. Due to this constitution, the motor portion sensor 71 and the output portion sensor 72 can be stably held at a predetermined position. In addition, a board surface of the control board 60 is orthogonal to the axial direction. Due to this constitution, the axial positions of the motor portion sensor 71 and the output portion sensor 72 are aligned. Therefore, positioning of the motor portion sensor 71 and the motor portion sensor magnet 74 and positioning of the output portion sensor 72 and the output portion sensor magnet 43 become easy. Accordingly, workability of assembling the sensors is improved.

A drive circuit for driving the motor portion 20 is mounted in the control board 60. Signal lines of the motor portion sensor 71 and the output portion sensor 72 are connected to the metal terminal 80a of the external connector 80 via a wiring on the control board 60. When a control IC for controlling the drive circuit is mounted on the control board 60, the signal line of the motor portion sensor 71 is connected to the control IC. The signal line of the output portion sensor 72 may be connected to the control IC.

The control board 60 may have a constitution in which only the motor portion sensor 71, the output portion sensor 72, and peripheral circuits thereof are mounted, without having the drive circuit or the control IC mounted thereon.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-11. (canceled)

12. An electric actuator comprising:
a motor that includes a motor shaft extending axially;
a decelerator that is joined to one axial side of the motor shaft;
an output that includes an output shaft to which rotation of the motor shaft is transmitted via the decelerator; and
a control board that is electrically connected to at least the motor; wherein
the motor and the output are disposed radially side by side with respect to the motor;
the control board extends from a position axially overlapping the motor shaft to a position axially overlapping the output shaft; and
the control board includes a motor sensor to detect a rotation angle of the motor shaft, and an output sensor to detect a rotation angle of a driven shaft joined to the output shaft.

13. The electric actuator according to claim 12, further comprising:
a motor sensor magnet that rotates together with the motor shaft; and
an output sensor magnet that rotates together with the driven shaft; wherein
a total volume of the output sensor magnet is larger than a total volume of the motor sensor magnet.

14. The electric actuator according to claim 13, wherein
the motor sensor magnet and the output sensor magnet radially overlap each other.

15. The electric actuator according to claim 13, wherein
the motor includes a rotor attached to the motor shaft, a stator surrounding an outer circumference of the rotor, and a motor holder that accommodates the rotor and the stator; and
the motor sensor magnet is disposed at a portion protruding outward from the motor holder of the motor shaft.

16. The electric actuator according to claim 15, wherein
the output sensor magnet is positioned on a side on an outer circumferential surface of the motor holder.

17. The electric actuator according to claim 15, wherein
the motor holder includes a lid facing the control board; and
the lid, the motor sensor magnet, and the output sensor magnet radially overlap each other.

18. The electric actuator according to claim 15, wherein
the motor holder is made of a non-magnetic material.

19. The electric actuator according to claim 12, wherein
the control board is a rigid substrate, and a board surface of the control board is orthogonal or substantially orthogonal to an axial direction.

20. The electric actuator according to claim 12, wherein
the motor sensor includes a Hall element.

21. The electric actuator according to claim 12, wherein
the output sensor includes a magneto-restrictive element.

22. The electric actuator according to claim 12, wherein
the output sensor includes a magneto-restrictive element and a Hall element.
